(19) United States
(12) Patent Application Publication
(10) Pub. No.: US 2012/0192546 A1
(43) Pub. Date: Aug. 2, 2012

(54) Catalytic Converter for a Pulse Detonation Turbine Engine

(75) Inventors: Venkat Eswarlu Tangirala, Niskayuna, NY (US); Narendra Joshi, Niskayuna, NY (US); Danielle Kalitan, Niskayuna, NY (US); Fuhua Ma, Niskayuna, NY (US); Thomas Lavertu, Clifton Park, NY (US)

(73) Assignee: GENERAL ELECTRIC COMPANY, Schnectady, NY (US)

(21) Appl. No.: 13/015,617

(22) Filed: Jan. 28, 2011

(51) Int. Cl. F02K 7/02

(52) U.S. Cl. 60/249; 60/685

(57) ABSTRACT

The present application provides a pulse detonation turbine engine. The pulse detonation turbine engine may include one or more pulse detonation combustors to produce a flow of combustion gases, a turbine positioned downstream of the pulse detonation combustors such that the flow of combustion gases drives the turbine, and a catalytic converter positioned downstream of the pulse detonation combustors such that the flow of combustion gases passes therethrough.

### TECHNICAL FIELD

The present application relates generally to pulse detonation turbine engines and more particularly relates to a pulse detonation turbine engine with a catalytic converter positioned downstream of one or more pulse detonation combustors to minimize or reduce undesirable emissions therein.

### BACKGROUND OF THE INVENTION

Recent developments with pulse detonation combustors and engines have focused on practical applications such as generating additional thrust/propulsion for aircraft engines and to improve overall performance in ground-based power generation systems. Known pulse detonation combustors and engines generally operate with a detonation process having a pressure rise as compared to conventional engines operating with a constant pressure deflagration. Specifically, air and fuel are mixed within a pulse detonation chamber and ignited to produce a combustion pressure wave. The combustion pressure wave transitions into a detonation wave followed by combustion gases that produce thrust as they are exhausted from the engine. As such, pulse detonation combustors and engines have the potential to operate at higher thermodynamic efficiencies than generally may be achieved with conventional deflagration-based engines.

Undesirable emissions, however, currently may be an issue for any combustion process other than deflagration. Even when the chemical reactions reach equilibrium in a detonative combustion process, undesirable emissions such as carbon monoxide (CO) and nitrogen oxides (NOₓ) may be present at levels higher than produced by a comparable constant pressure combustor. Moreover, these emissions generally reduce the combustion efficiency of the pulse detonation combustor in a pulse detonation turbine engine. A reduction in levels of emissions such as carbon monoxide and nit oxides thus is an issue in the adaptation of a pulse detonation turbine engine as an energy/propulsion conversion device.

There is thus a desire for improved pulse detonation turbine engine designs. Such improved designs preferably may limit undesirable emissions while maintaining or increasing overall system efficiency. Moreover, such designs preferably may involve minimal downtime and maintenance costs.

### SUMMARY OF THE INVENTION

The present application thus provides a pulse detonation turbine engine. The pulse detonation turbine engine may include one or more pulse detonation combustors to produce a flow of combustion gases, a turbine positioned downstream of the pulse detonation combustors such that the flow of combustion gases drives the turbine, and a catalytic converter positioned downstream of the pulse detonation combustors such that the flow of combustion gases passes therethrough.

The present application further provides a method of minimizing or eliminating one or more undesirable emissions in a flow of combustion gases in a pulse detonation turbine engine. The method may include the steps of generating the flow of combustion gases with the undesirable emission therein in one or more pulse detonation combustors, driving a turbine with the flow of combustion gases, and passing the flow of combustion gases through a catalytic converter to minimize or eliminate the undesirable emissions contained therein.

The present application further provides a pulse detonation turbine engine. The pulse detonation turbine engine may include one or more pulse detonation combustors for producing a flow of combustion gases, a high pressure turbine positioned downstream of the pulse detonation combustors such that the flow of combustion gases drives the high pressure turbine, a catalytic converter positioned downstream of the high pressure turbine such that the flow of combustion gases passes therethrough, and a low pressure turbine positioned downstream of the catalytic converter such that heat produced in the catalytic converter drives in part the low pressure turbine.

These and other features and improvements of the present application will become apparent to one of ordinary skill in the art upon review of the following detailed description when taken in conjunction with the several drawings and the appended claims.

### BRIEF DESCRIPTION OF THE DRAWINGS

FIG. 1 is a side cross-sectional view of a known pulse detonation combustor.

FIG. 2 is a schematic view of a known pulse detonation turbine engine with a number of pulse detonation combustors.

FIG. 3 is a schematic view of a pulse detonation turbine engine as may be described herein with a catalytic converter.

FIG. 4 is a partial side cross-section view of the catalytic converter of the pulse detonation turbine engine of FIG. 3.

### DETAILED DESCRIPTION

As used herein, the term “pulse detonation combustor” refers to a device or a system that produces both a pressure rise and a velocity increase from the detonation or quasi-detonation of a fuel and an oxidizer. The pulse detonation combustor may be operated in a repeating mode to produce multiple detonations or quasi-detonations within the device. A “detonation” may be a supersonic combustion in which a shock wave is coupled to a combustion zone. The shock may be sustained by the energy release from the combustion zone so as to result in combustion products at a higher pressure than the combustion reactants. A “quasi-detonation” may be a supersonic turbulent combustion process that produces a pressure rise and a velocity increase higher than the pressure rise and the velocity increase produced by a sub-sonic deflagration wave, i.e., detonation and fast flames. For simplicity, the terms “detonation” or “detonation wave” as used herein will include both detonations and quasi-detonations.

Exemplary pulse detonation combustors, some of which will be discussed in further detail below, include an ignition device for igniting a combustion of a fuel/oxidizer mixture and a detonation chamber in which pressure wave fronts initiated by the combustion coalesce to produce a detonation wave. Each detonation or quasi-detonation may be initiated either by an external ignition source, such as a spark discharge, laser pulse, heat source, or plasma igniter, or by gas dynamic processes such as shock focusing, auto-ignition, or an existing detonation wave from another source (cross-fire ignition). The detonation chamber geometry may allow the pressure increase behind the detonation wave to drive the detonation wave and also to blow the combustion products themselves out an exhaust of the pulse detonation combustor. Other components and other configurations may be used herein.

Various combustion chamber geometries may support detonation formation, including round chambers, tubes, resonating cavities, reflection regions, and annular chambers. Such combustion chamber designs may be of constant or varying cross-section, both in area and shape. Exemplary combustion chambers include cylindrical tubes and tubes having polygonal cross-sections, such as, for example, hexagonal tubes. As used herein, “downstream” refers to a direction of flow of at least one of the fuel or the oxidizer.

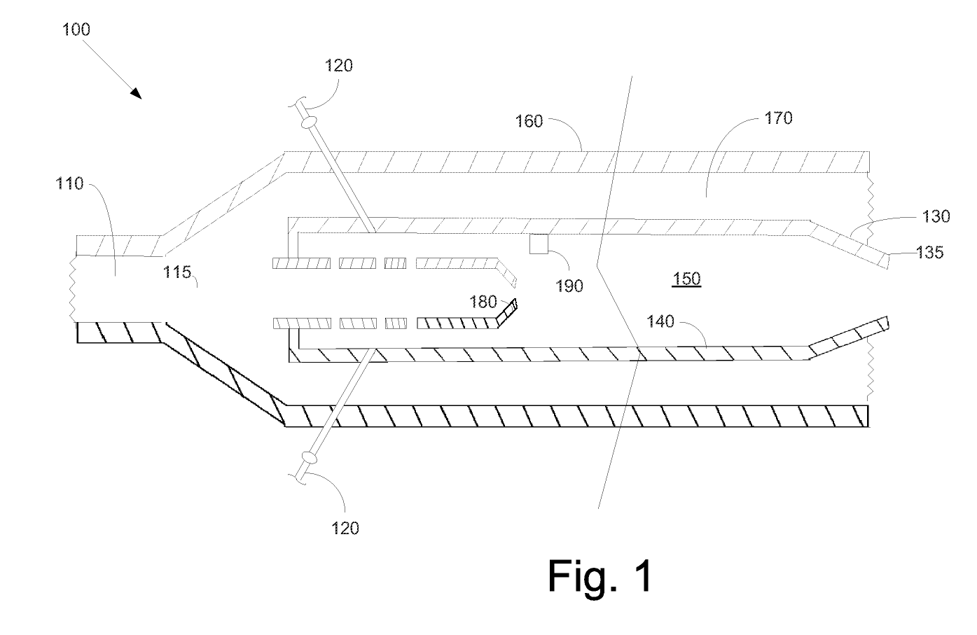

Referring now to the drawings, in which like numbers refer to like elements throughout the several views, FIG. 1 shows a generalized example of a pulse detonation combustor 100 as may be described and used herein. The pulse detonation combustor 100 may extend from an upstream head end 115 that includes an air inlet 110 and one or more fuel inlets 120 to an exit nozzle 130 at an opposed downstream end 135. A combustion tube 140 may extend from the head end 115 to the nozzle 130 at the downstream end 135. The combustion tube 140 defines a combustion chamber 150 therein. A casing 160 may surround the combustor tube 140. The casing 160 may be in communication with the air end 110 at the head end 115 and may extend to or beyond the nozzle 130 at the downstream end 135. The casing 160 and the combustion tube 140 may define a bypass duct 170 therebetween. Other components and other configurations may be used herein for detonation and/or quasi-detonation.

The air inlet 110 may be connected to a source of pressurized air such as a compressor. The pressurized air may be used to fill and purge the combustion chamber 150 and also may serve as an oxidizer for the combustion of the fuel. The air inlet 110 may be in communication with a center body 180. The center body 180 may extend into the combustion chamber 150. The center body 180 may have any size, shape, or configuration. Likewise, the fuel inlet 120 may be connected to a supply fuel that may be burned within the combustion chamber 150. The fuel may be injected into the combustion chamber 150 so as to mix with the airflow.

An ignition device 190 may be positioned downstream of the air inlet 110 and the fuel inlet 120. The ignition device 190 may be connected to a controller so as to operate the ignition device 190 at desired times and sequences as well as providing feedbacks signals to monitor operations. As described above, any type of ignition device 190 may be used herein. The fuel and the air may be ignited by the ignition device 190 into a combustion flow so as to produce the resultant detonation waves. A portion of the airflow also may pass through the bypass duct 170. This portion of the airflow may serve to cool the tube 140, the combustion chamber 150, and the nozzle 130. Other components and other configurations may be used herein. Any type of pulse detonation combustor 100 may be used herein.

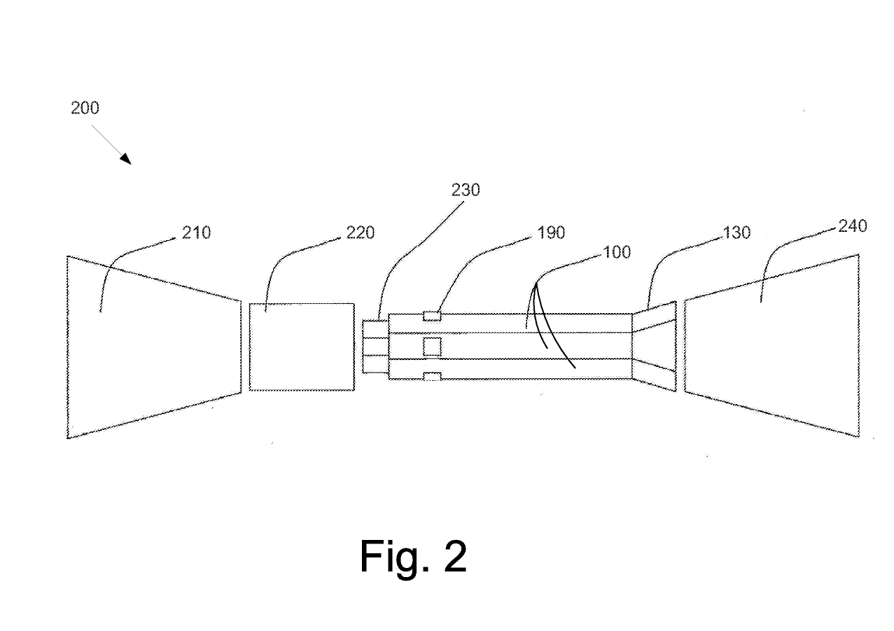

FIG. 2 shows a generalized example of a pulse detonation turbine engine 200 using a number of the pulse detonation combustors 100. Generally described, the pulse detonation turbine engine 200 may include a compressor 210 to compress an incoming flow of air. The compressor 210 may be in communication with an inlet system 220 with a number of inlet valves 230. Each inlet valve 230 may be in communication with a pulse detonation combustor 100 as described above so as to mix the compressed flow of air with a compressed flow of fuel for combustion therein. The pulse detonation combustors 100 may be in communication with a turbine 240 via the nozzles 130 or other type of plenum. The hot combustion gases from the pulse detonation combustors 100 drive the turbine so as to produce mechanical work. Other configurations and other components may be used herein. Any type of puke detonation turbine engine 200 may be used herein with any number or type of pulse detonation combustors 100.

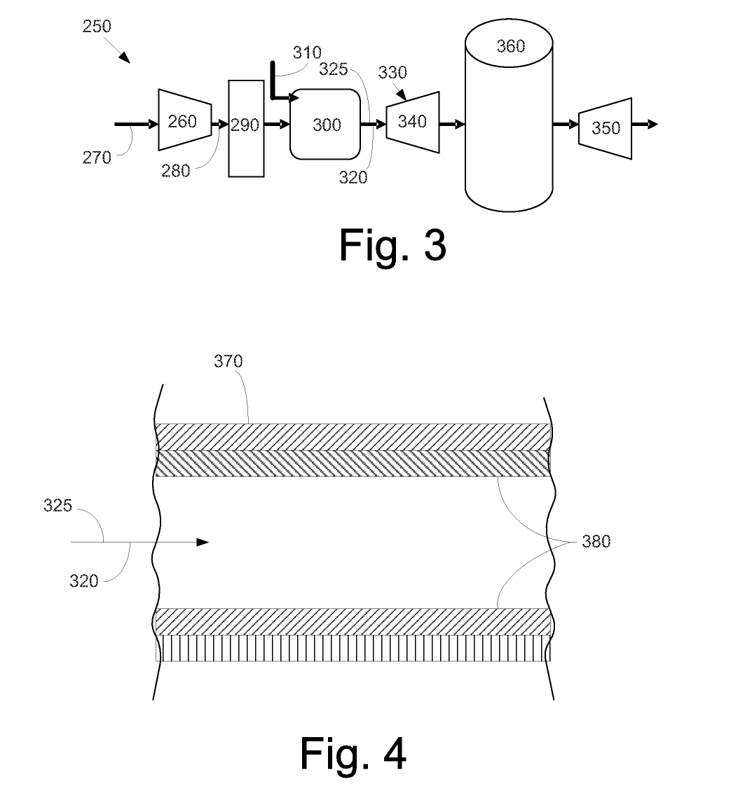

FIG. 3 is a schematic view of a pulse detonation turbine engine 250 as may be described herein. Similar to the pulse detonation turbine engine 200 described above, the pulse detonation turbine engine 250 also includes a compressor 260 to compress an incoming flow of ambient air 270 to a flow of compressed air 280. The compressor 260 may be in communication with an inlet system 290 with a number of valves therein. The inlet system 290 may be in communication with a number of pulse detonation combustors 300. As described above, the pulse detonation combustors 300 mix the compressed flow of air 280 with a compressed flow of fuel 310 and ignite the mixture to create a flow of combustion gases 320. The flow of combustion gases 320 is in turn delivered to a turbine 330. The flow of combustion gases 320 drives the turbine 330 so as to produce mechanical work. In this example, the turbine 330 may be a two stage turbine with a high pressure turbine 340 and a low pressure turbine 350.

As described above, the flow of combustion gases 320 leaving the pulse detonation combustors 300 may have one or more undesirable emissions 325 such as carbon monoxide and nitrogen oxides therein. The pulse detonation turbine engine 250 thus may position a catalytic converter 360 between the high pressure turbine 340 and the low pressure turbine 350 so as to minimize or eliminate the undesirable emissions 325 therein. Generally described, the catalytic converter 360 works by using a catalyst to stimulate a chemical reaction in which the combustion emissions 325 are converted to less-toxic substances.

As is shown in FIG. 4, the catalytic converter 360 may be any type of air plenum 370 with a catalyst or catalytic coating 380 thereon. The catalytic converter 360 may have any desired size, shape, or configuration. The particular type of catalyst 380 may vary with the nature of the flow of fuel 310 and other variables. The catalyst 380, for example, enables oxidation of the carbon monoxide. This oxidation may release heat at a lower temperature than that of the detonation temperature where dissociative reactions may dominate. The carbon monoxide may be oxidized with unreacted hydrocarbons into water and carbon monoxide. Likewise, the nitrogen oxides may be reduced to nitrogen and carbon dioxide. The catalyst 380 may be applied via a plasma spray and other types of applications. The catalyst 380 may be a transition metal or an oxide thereof such as nickel oxide, chromium oxide, and magnesium oxide; noble metals such as platinum and palladium; and combinations thereof. Other examples of the catalyst 380 may include base metals such as vanadium and tungsten. Similar materials also may be used.

In use, the compressed flow of air 280 from the compressor 260 is mixed with the compressed flow of fuel 310 in the pulse detonation combustors 300 to produce the combustion gases 320. The combustion gases 320 drive the high pressure turbine 340 where mechanical work is extracted. The combustion gases 320 then pass through the catalytic converter 360 where the undesirable emissions 325 therein may be minimized and/or eliminated. Specifically, carbon monoxide may be oxidized and hence may release heat in an exothermic process. The heat produced in the catalytic converter 360 continues downstream with the flow of combustion gases 320 where useful work may be extracted in the low pressure turbine 350. As such, the catalytic converter 360 not only reduces the undesirable emissions 325, but also may improve the overall performance and efficiency of the pulse detonation turbine engine 250. Likewise, nitrogen oxide levels may be reduced therein. Other types of undesirable emissions 325 also may be reduced or eliminated.

The pulse detonation turbine engine 250 thus provides improved performance and efficiency with lower overall emissions. Not only are the undesirable emissions minimized 325, but these emissions 325 are used for this performance improvement. The use of the catalytic converter 360 also reduces the pressure and flow fluctuations exiting the high pressure turbine 340 so as to provide a lower pressure smoothed flow to the low pressure turbine 350. This smoothed flow thus facilitates the use of standard turbines herein.

It should be apparent that the foregoing relates only to certain embodiments of the present application and that numerous changes and modifications may be made herein by one of ordinary skill in the art without departing from the general spirit and scope of the invention as defined by the following claims and the equivalents thereof.

We claim:

1. A pulse detonation turbine engine, comprising:
one or more pulse detonation combustors;
the one or more pulse detonation combustors producing a flow of combustion gases;
a turbine positioned downstream of the one or more pulse detonation combustors such that the flow of combustion gases drives the turbine; and
a catalytic converter positioned downstream of the one or more pulse detonation combustors such that the flow of combustion gases passes therethrough.

2. The pulse detonation turbine engine of claim 1, wherein the turbine comprises a high pressure turbine positioned upstream of the catalytic converter.

3. The pulse detonation turbine engine of claim 1, wherein the turbine comprises a low pressure turbine positioned downstream of the catalytic converter such that heat produced in the catalytic converter drives in part the low pressure turbine.

4. The puke detonation turbine engine of claim 1, wherein the catalytic converter comprises an air plenum.

5. The pulse detonation turbine engine of claim 1, wherein the catalytic converter comprises a catalyst therein.

6. The pulse detonation turbine engine of claim 5, wherein the catalyst comprises a transition metal or an oxide thereof.

7. The pulse detonation turbine engine of claim 5, wherein the catalyst comprises a noble metal.

8. The pulse detonation turbine engine of claim 1, wherein the flow of combustion gases comprises one or more undesirable emissions therein and wherein the catalytic converter minimizes or eliminates the one or more undesirable emissions.

9. The puke detonation turbine engine of claim 8, wherein the one or more undesirable emissions comprise carbon monoxide and wherein the catalytic converter oxidizes the carbon monoxide.

10. The puke detonation turbine engine of claim 8, wherein the one or more undesirable emissions comprise nitrogen oxides and wherein the catalytic converter reduces the nitrogen oxides.

11. A method of minimizing or eliminating one or more undesirable emissions in a flow of combustion gases in a pulse detonation turbine engine, comprising:
generating the flow of combustion gases with the one or more undesirable emission therein in one or more pulse detonation combustors;
driving a turbine with the flow of combustion gases; and
passing the flow of combustion gases through a catalytic converter to minimize or eliminate one or more of the undesirable emissions therein.

12. The method of claim 11, wherein the step of driving the turbine comprises driving a high pressure turbine.

13. The method of claim 11, wherein the step of passing the flow of combustion gases through a catalytic converter to minimize or eliminate one or more of the undesirable emissions therein comprises oxidizing carbon monoxide and releasing heat therein.

14. The method of claim 13, further comprising the step of driving a low pressure turbine in part with the heat released from oxidizing the carbon monoxide within the catalytic converter.

15. The method of claim 11, wherein the step of passing the flow of combustion gases through a catalytic converter to minimize or eliminate one or more of the undesirable emissions therein comprises reducing nitrogen oxides therein.

16. A pulse detonation turbine engine, comprising:
one or more pulse detonation combustors;
the one or more pulse detonation combustors producing a flow of combustion gases;
a high pressure turbine positioned downstream of the one or more pulse detonation combustors such that the flow of combustion gases drives the high pressure turbine;
a catalytic converter positioned downstream of the high pressure turbine such the flow of combustion gases passes therethrough; and
a low pressure turbine positioned downstream of the catalytic converter such that heat produced in the catalytic converter drives in part the low pressure turbine.

17. The pulse detonation turbine engine of claim 16, wherein the catalytic converter comprises an air plenum.

18. The pulse detonation turbine engine of claim 16, wherein the flow of combustion gases comprises one or more undesirable emissions therein and wherein the catalytic converter minimizes or eliminates the one or more undesirable emissions.

19. The pulse detonation turbine engine of claim 18, wherein the one or more undesirable emissions comprise carbon monoxide and wherein the catalytic converter oxidizes the carbon monoxide.

20. The pulse detonation turbine engine of claim 18, wherein the one or more undesirable emissions comprise nitrogen oxides and wherein the catalytic converter reduces the nitrogen oxides.
